(19) United States
(12) Patent Application Publication
(10) Pub. No.: US 2024/0429756 A1
(43) Pub. Date: Dec. 26, 2024

(54) MULTI-COIL TANDEM ARRANGEMENT FOR WIRELESS CHARGER

(71) Applicant: Microsoft Technology Licensing, LLC, Redmond, WA (US)

(72) Inventors: Prasad RAGHAVENDRA, Colleyville, TX (US); David Allen WEBBER, Bellevue, WA (US); Alan HSIAO, Bellevue, WA (US); Jayaprakash POOJALI, Tamil Nadu (IN); Mahesh Raja PERUMAL, Tamil Nadu (IN)

(21) Appl. No.: 18/212,056

(22) Filed: Jun. 20, 2023

(51) Int. Cl. H02J 50/90; H02J 50/10; H02J 50/40; H02J 50/60; H02J 50/80

(52) U.S. Cl. CPC H02J 50/90; H02J 50/10; H02J 50/402; H02J 50/60; H02J 50/80

(57) ABSTRACT

A device may include a first transmission coil, wherein the first transmission coil generates a first magnetic field toward a charging region. A device may include a second transmission coil adjacent to the first transmission coil, wherein the second transmission coil generates a second magnetic field toward the charging region. A device may include a management device in communication with the first transmission coil and the second transmission coil, the management device configured to: determine a presence of a receiving coil proximate to a first transmission coil and a second transmission coil, determine a proportional alignment value of at least the first transmission coil and the second transmission coil with the receiving coil; and select and drive at least one of the first transmission coil and the second transmission coil according to the proportional alignment values.

### BACKGROUND

### Background and Relevant Art

Electronic devices include rechargeable batteries. Different standards, including proprietary standards, or physical electrical connectors for charging electronic devices present a challenge for convenient and reliable charging. Wireless charging allows an electronic device to charge a battery with a current in a receiving coil induced by an external magnetic field. The efficiency of the charging is proportional to the alignment of the receiving coil with the transmission coil producing the magnetic field.

### BRIEF SUMMARY

In some aspects, the techniques described herein relate to a device including: a first transmission coil, wherein the first transmission coil generates a first magnetic field toward a charging region; a second transmission coil adjacent to the first transmission coil, wherein the second transmission coil generates a second magnetic field toward the charging region; and a management device in communication with the first transmission coil and the second transmission coil, the management device configured to: determine a presence of a receiving coil proximate to a first transmission coil and a second transmission coil; determine a proportional alignment value of at least the first transmission coil and the second transmission coil with the receiving coil; and select and drive at least one of the first transmission coil and the second transmission coil according to the proportional alignment values.

In some aspects, the techniques described herein relate to a method including: determining a presence of a receiving coil proximate to a first transmission coil and a second transmission coil; determining a proportional alignment value of at least the first transmission coil and the second transmission coil with the receiving coil; and selecting and driving at least one of the first transmission coil and the second transmission coil according to the proportional alignment value.

In some aspects, the techniques described herein relate to a method including: transmitting a first detection pulse with a first transmission coil of a charging device; detecting an object proximate the first transmission coil; failing to receive an expected response at the first transmission coil; establishing a first foreign object timeout at the first transmission coil; and transmitting a second presence detection pulse with a second transmission coil of the charging device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a perspective view of a host device with an accessory device docked thereto, according to at least one embodiment of the present disclosure.

FIG. 2 is a side view of an accessory device resting on a charging device, according to at least one embodiment of the present disclosure.

FIG. 3 is a schematic representation of a charging device including a transmission coil, according to at least one embodiment of the present disclosure.

FIGS. 4-1 and 4-2 illustrate different alignments of a receiving coil with a transmission coil array, according to at least one embodiment of the present disclosure.

FIG. 5 is a schematic representation of adjacent transmission coils, according to at least one embodiment of the present disclosure.

FIG. 6 is a transverse cross-sectional view of a charging device with a plurality of transmission coils out-of-plane with one another, according to at least one embodiment of the present disclosure.

FIG. 7 is a flowchart illustrating a method of wirelessly transferring energy to a receiving coil with a plurality of transmission coils, according to at least one embodiment of the present disclosure.

FIG. 8 is a flowchart illustrating a method of providing a foreign object detection (FOD) timeout for one or more transmission coils in a charging device, according to at least one embodiment of the present disclosure.

### DETAILED DESCRIPTION

The present disclosure relates generally to systems and methods for charging an electronic device. More particularly, the present disclosure relates to systems and methods for wireless charging of an electronic device. In some embodiments, a user positions an electronic device on or proximate to a charging device to charge the electronic device. In some embodiments, the charging device is part of a standalone dock that supports the charging device and is connected to a power source. In some embodiments, the charging device is part of a host electronic device, such as a laptop computer, tablet computer, desktop computer, hybrid computer, smartphone or other mobile computing device, keyboard, monitor, television, refrigerator, or other electronic device including or connected to a power source. In some embodiments, the charging device is powered by a battery of the host electronic device, and the charging device is limited in power output based on the battery of the host electronic device.

In some embodiments, a charging device includes a transmission coil that produces a magnetic field. The magnetic field of the transmission coil can magnetically couple the transmission coil to a receiving coil of another electronic device to induce an electric current in the receiving coil. The induced electric current, in some embodiments, is used to power one or more components of the electronic device. The induced electric current, in some embodiments, is used to charge a battery of the electronic device.

In some embodiments, a charging efficiency of the magnetic charging between the transmission coil and the receiving coil is proportional to the alignment of the magnetic field of the transmission coil and the receiving coil. For example, the charging efficiency is the amperage of the induced current in the receiving coil relative to a transmission current used to drive the transmission coil. As the distance between the transmission coil and the receiving coil increases, the charging efficiency decreases. As the lateral alignment of the transmission coil and the receiving coil decreases, the charging efficiency decreases.

In some embodiments, a charging device includes a plurality of transmission coils. An array of a plurality of transmission coils can allow a user to position an electronic device in a variety of positions on the charging device and still allow the receiving coil to receive magnetic field to induce a current in the receiving coil. In some embodiments, such as a charging device that is powered by a battery, the transmission current is limited, and the charging device drives the transmission coils proximate to the receiving coil. In some embodiments, driving the transmission coils proximate to the receiving coil conserves power. In some embodiments, the charging device selects a plurality of coils and drives the plurality of coils with transmission currents that are proportional to one another based on a determined relative alignment of the receiving coil proximate the plurality of coils. In some embodiments, the charging device grounds one or more unselected coils.

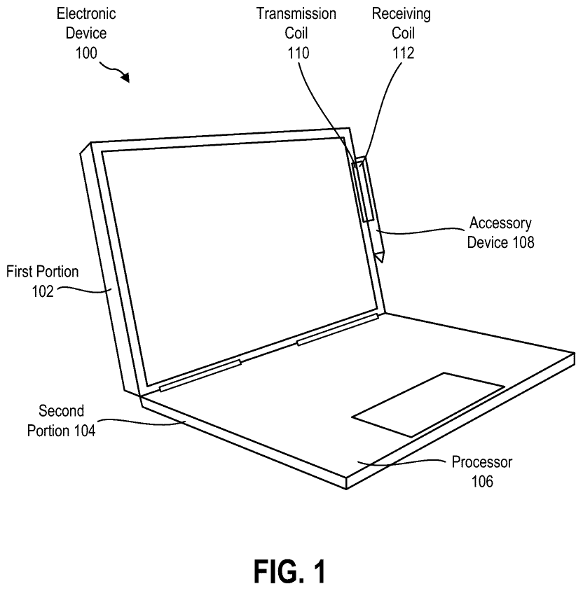

FIG. 1 is a perspective view of an embodiment of a host device 100 with an accessory device 108 docked thereto. The host device 100 illustrated in FIG. 1 is a laptop computer having a first portion 102 and a second portion 104 that are movable relative to one another, and the accessory device 108 is a stylus that pairs with the host device 100 to provide inputs and inking functionality.

In some embodiments, a processor 106 of the host device 100 is located in the second portion 104 and is in data communication with a transmission coil 110 located in the first portion 102. When the accessory device 108 is positioned in proximity to the transmission coil 110, a receiving coil 112 receives a transmission energy from the transmission coil 110, and the accessory device 108 enters a docked mode. In the illustrated embodiment, the bezel of the first portion 102 that contains the transmission coil 110 acts as the charging device for the accessory device 108. In some embodiments, the charging device includes a retention mechanism, such as a mechanical retention mechanism, a magnetic retention mechanism, or an adhesive retention mechanism, to hold the accessory device 108 in proximity to the charging device. In some embodiments, the charging device is oriented such that gravity holds the accessory device 108 in proximity to the charging device.

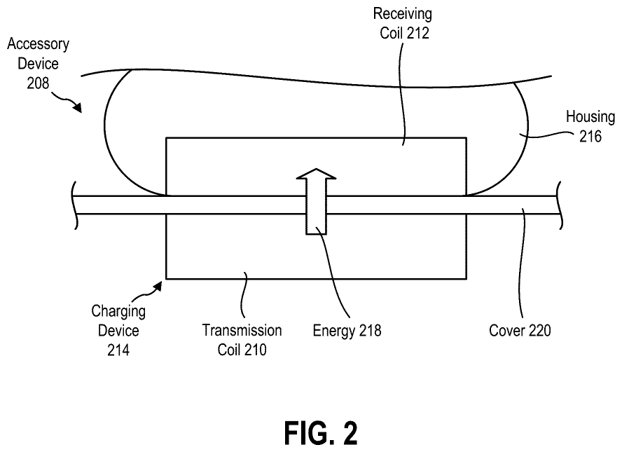

FIG. 2 is a side view of another embodiment of an accessory device 208 resting on a charging device 214. In some embodiments, the accessory device 208 has a housing 216, with the receiving coil 212 positioned at or near a surface of the housing 216. The receiving coil 212 is positioned proximate a transmission coil 210 of the charging device 214, such that a transmission energy 218 is transmitted to the receiving coil 212.

In some embodiments, the transmission energy 218 is transmitted through one or more parts of the accessory device 208 and/or charging device 214 en route to the receiving coil 212. In some embodiments, the housing 216 of the accessory device 208 and/or a cover 220 of the charging device 214 are at least partly transparent to the transmission energy 218. In the illustrated embodiment with a transmission coil 210 that generates a magnetic field, the cover 220 is a non-magnetic material to allow the transmission energy 218 to pass through the cover 220 to the receiving coil 212.

In some embodiments, the accessory device is a stylus, such as described in relation to FIG. 1. In some embodiments, the accessory device is a computing mouse. In some embodiments, the accessory device is a keyboard. In some embodiments, the accessory device is a touch-sensitive device. In some embodiments, the accessory device is an audio device, such as a wireless speaker, headphones, earphones, or other audio device capable of generating audio signals to communicate with a user.

In some embodiments, the host device is a computing device, including but not limited to a laptop computer, hybrid computer, foldable computer, tablet computer, smartphone, wearable computing device, or other computing device. In some embodiments, the host device includes a charging device that contains a transmission coil. The transmission coil produces a magnetic field in an outward direction from the charging device. When a transmission current is applied to the transmission coil in the charging device, the transmission coil generates a magnetic field that extends beyond an outer surface of the charging device.

A receiving coil positioned within the magnetic field proximate the dock experiences the magnetic field. A varying magnetic field induces a current in the receiving coil. In some embodiments, the coils are configured to implement a wireless charging protocol.

In some embodiments, the transmission coil transmits energy from the transmission coil to the receiver to wirelessly charge a power supply of the accessory device. In some embodiments, the power supply is a battery. In some embodiments, the power supply is a capacitor. In some embodiments, the power supply is an alternating current (AC) power source. In some embodiments, the charging device modulates the transmission energy from the transmission coil to the receiving coil to communicate data from the charging device and/or host device to the accessory device. In some embodiments, the host device communicates with the charging device. In some embodiments, the host device communicates with the charging device.

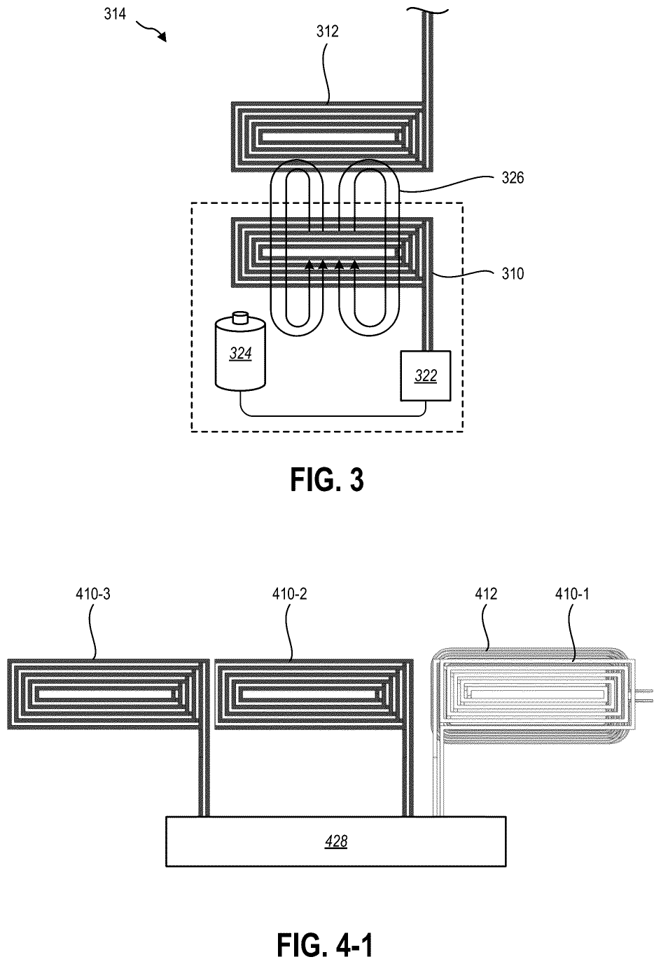

FIG. 3 is a schematic representation of a charging device 314 including a transmission coil 310. The transmission coil 310 is in electrical communication via an electrical conduit (e.g., a wire) with a controller 322. The controller 322 is configured to drive the transmission coil 310 with a transmission current from a power source 324. Changes in the transmission current controlled by the controller 322 cause the transmission coil 310 to produce a changing magnetic field 326.

In some embodiments, a receiving coil 312 is positioned within the magnetic field 326. The changes in the magnetic field 326 controlled by the controller 322 induce an induced current in the receiving coil 312. As described herein, the charging efficiency between the transmission current and the induced current is proportional to the distance between the transmission coil 310 and the receiving coil 312, as well as proportional to the alignment of the transmission coil 310 and the receiving coil 312. Distance between the transmission coil 310 and the receiving coil 312 is primarily set by the position of the coils in the respective devices. However, alignment becomes increasingly important in a multi-coil array.

FIG. 4-1 and FIG. 4-2 illustrate embodiments of multi-coil arrays that contain a plurality of transmission coils 410-1, 410-2, 410-3. In some embodiments, the array contains at least a first transmission coil 410-1 and a second transmission coil 420-2. In some embodiments, each of the transmission coils 410-1, 410-2, 410-3 is in electrical communication with a management device 428. In some embodiments, the management device 428 is a controller, such as the controller 322 described in relation to FIG. 3, and the management device 428 directs current from a power source to each of the transmission coils 410-1, 410-2, 410-3 in sequence.

In some embodiments, the receiving coil 412 is aligned with a first transmission coil 410-1 of the plurality of transmission coils 410-1, 410-2, 410-3, and the management device 428 (e.g., controller) drives the first transmission coil 410-1 with a transmission current from a power source to create a first magnetic field.

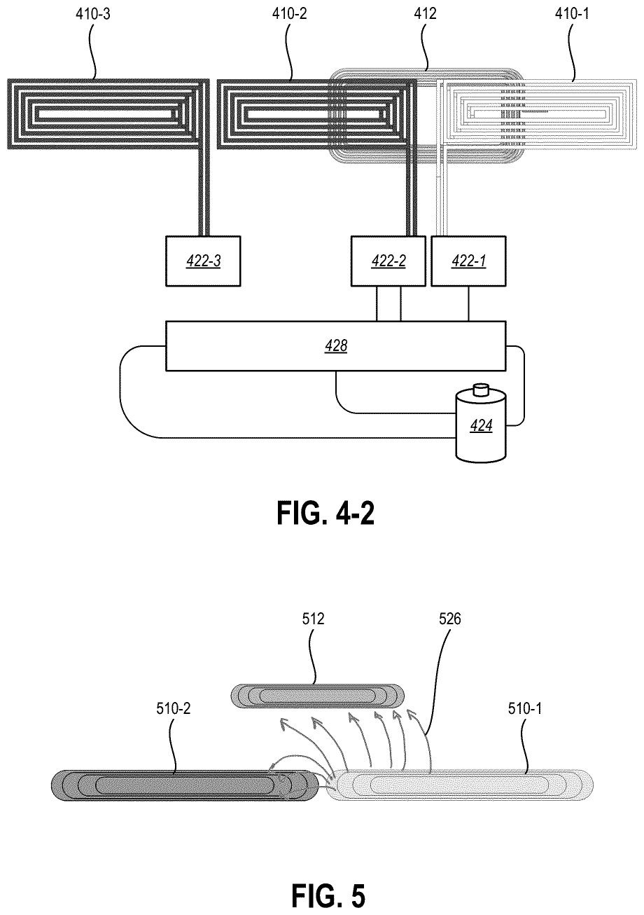

Referring now to FIG. 4-2, in some embodiments, the receiving coil 412 is misaligned with the first transmission coil 410-1 and is partially aligned with both the first transmission coil 410-1 and the second transmission coil 410-2. In some embodiments, the management device 428 selects one of the first transmission coil 410-1 and the second transmission coil 410-2 to drive with the transmission current. In some embodiments, the management device 428 grounds the unselected transmission coil or otherwise disables the unselected transmission coil. In some embodiments, the management device 428 drives both the first transmission coil 410-1 with a first transmission current and the second transmission coil 410-2 with a second transmission current. In some embodiments, the output ratio of the first transmission current and the second transmission current is based at least partially on a proportional alignment value representing the relative alignment of the receiving coil 412 with each of the first transmission coil 410-1 and the second transmission coil 410-2.

In the illustrated embodiment of FIG. 4-2, the receiving coil 412 is located approximately 50% aligned with the first transmission coil 410-1 and 50% aligned with the second transmission coil 410-2. In such an example, the proportional alignment value for each of the first transmission coil 410-1 and the second transmission coil 410-2 is 0.5. In the illustrated embodiment of FIG. 4-1, the receiving coil 412 is located approximately 100% aligned with the first transmission coil 410-1 and 0% aligned with the second transmission coil 410-2. The proportional alignment value for the first transmission coil 410-1 is approximately 1.0 and the second transmission coil 410-2 is 0.0.

In some embodiments, a charging device 414 includes a visual indicator, such as one or more light emitted diodes (LEDs), that activates to indicate the alignment of a receiving coil relative to the transmission coils. In some embodiments, the activation of the visual indicator is based at least partially on the proportional alignment values. For example, a proportional alignment value for the first transmission coil 410-1 of 1.0 illuminates a first visual indicator at full brightness, and a proportional alignment value for the second transmission coil 410-2 of 0.5 illuminates a second visual indicator at half brightness.

In some embodiments, the array of transmission coils 410-1, 410-2, 410-3 is in communication with the management device 428. In some embodiments, the management device 428 is in communication with the transmission coils 410-1, 410-2, 410-3 through controllers 422-1, 422-2, 422-3 associated with each of the transmission coils 410-1, 410-2, 410-3. The management device 428 instructs each of the controllers 422-1, 422-2, 422-3 to drive the transmission coils 410-1, 410-2, 410-3 with a determined transmission current.

In some embodiments, the management device 428 is a dedicated processor or integrated circuit. In some embodiments, the management device 428 is a general-purpose processor. In some embodiments, the management device 428 is a central processing unit (CPU) of the charging device (such as the charging device 214 of FIG. 2). In some embodiments, the management device 428 is a CPU of a host device (such as the host electronic device 100 of FIG. 1).

FIG. 5 is a schematic representation of adjacent transmission coils 510-1, 510-2 in a plane relative to a receiving coil 512 positioned equally aligned/misaligned with both the first transmission coil 510-1 and the second transmission coil 510-2. In some embodiments, a charging device drives a first transmission coil 510-1 and does not drive the second transmission coil 510-2. In some embodiments, the charging device drives the first transmission coil 510-1 and grounds the second transmission coil 510-2. When the first transmission coil 510-1 is driven and is generating a changing magnetic field 526, the first transmission coil 510-1 induces an induced current in the second transmission coil 510-2. Grounding the second transmission coil 510-2 protects the second transmission coil 510-2, the controller of the second transmission coil 510-2 (such as the second controllers 422-2 described in relation to FIG. 4-1), a management device of the array of coils 510-1, 510-2 (such as the management device 428 described in relation to FIG. 4-1 and/or FIG. 4-2), the electrical conduits therebetween, and other electrical components of the charging device from damage. FIG. 5 illustrates a transmission coil arrangement in which the first transmission coil 510-1 and second transmission coil 510-2 are substantially in-plane with one another. For example, the first transmission coil 510-1 is positioned in a first plane and the second transmission coil 510-2 is positioned substantially co-planar with and in the first plane. In some embodiments, the first transmission coil 510-1 and second transmission coil 510-2 are positioned in parallel but non-co-planar planes. In some embodiments, the first transmission coil 510-1 and second transmission coil 510-2 are positioned in non-parallel planes.

In some embodiments, the transmission coils 510-1, 510-2 are positioned and/or shaped to limit the mutual inductance of an induced current in the other transmission coil 510-1, 510-2. In some embodiments, the transmission coils 510-1, 510-2 each have an aspect ratio of no less than 5:1 in a longitudinal direction, and the transmission coils 510-1, 510-2 are positioned adjacent to one another in the longitudinal direction. For example, an array of two transmission coils 510-1, 510-2 each with an aspect ratio of no less than 5:1 in a longitudinal direction and positioned adjacent to one another in the longitudinal direction has an array aspect ratio of no less than 10:1. In some embodiments, arranging the relatively short aspects of the transmission coils 510-1, 510-2 proximate one another limits the inductance of an induced current in the second transmission coil 510-2 by the magnetic field 526 produced by the first transmission coil 510-1.

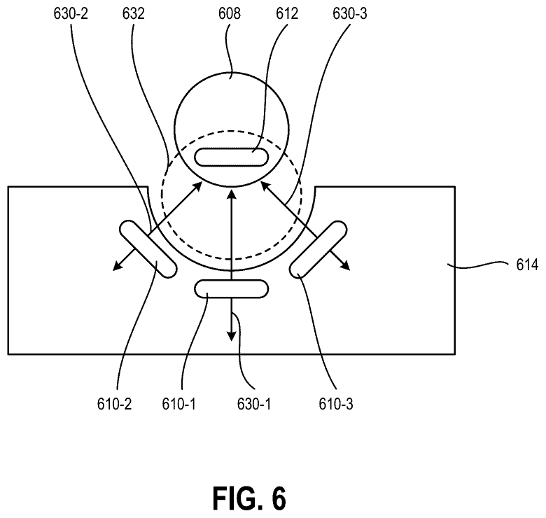

FIG. 6 is a transverse cross-sectional view of a charging device 614 with a plurality of transmission coils 610-1, 610-2, 610-3 out-of-plane with one another. The first transmission coil 610-1, the second transmission coil 610-2, and the third transmission coil 610-3 are out-of-plane with one another and each has a flux axis 630-1, 630-2, 630-3 that is non-parallel to one another. The flux axis 630-1, 630-2, 630-3 is the center axis of the magnetic field (such as the magnetic fields 326, 526 described herein) produced by each transmission coil 610-1, 610-2, 610-3 when driven with a transmission current.

In some embodiments, the magnetic fields of the transmission coils 610-1, 610-2, 610-3 define a charging region 632 in which the receiving coil 612 can receive the magnetic flux and an induced current can be induced in the receiving coil 612. However, just as with a lateral misalignment, a rotational or angular misalignment of the flux axis 630-1, 630-2, 630-3 and the plane of the receiving coil 612 can limit the charging efficiency. In a power-limited environment or in the interest of conserving power, the charging device 614 determines a proportional alignment value for each of the transmission coils 610-1, 610-2, 610-3 and selects one or more transmission coils 610-1, 610-2, 610-3 to drive to most efficiently transfer energy to the receiving coil 612.

In some embodiments, at least two of the flux axes are parallel to one another. In some embodiments, at least two of the flux axes are non-parallel to one another. In some embodiments, at least two of the transmission coils are co-planar and the flux axes of the at least two transmission coils are parallel.

In the illustrated embodiment of FIG. 6, the charging device 614 most efficiently transfers energy to the accessory device 608 containing the receiving coil 612 with the first transmission coil 610-1 because the first flux axis 630-1 is substantially normal to the plane of the receiving coil 612. In some embodiments, the proportional alignment value of the first transmission coil 610-1 is greater than the proportional alignment value of the second transmission coil 610-2 and third transmission coil 610-3, and a management device of the charging device 614 selects the first transmission coil 610-1 to drive the first transmission coil 610-1. In some embodiments, the management device of the charging device 614 grounds at least one of the unselected transmission coils (e.g., the second transmission coil 610-2 and third transmission coil 610-3). In some embodiments, the management device of the charging device 614 grounds all unselected transmission coils of the charging device 614.

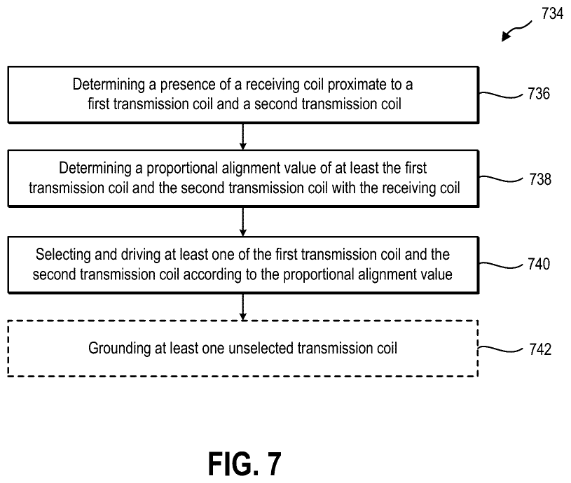

FIG. 7 is a flowchart illustrating a method 734 of wirelessly transferring energy to a receiving coil with a plurality of transmission coils. In some embodiments, the method 734 includes determining a presence of a receiving coil in a charging region at 736. In some embodiments, a management device of the charging device is in communication with the plurality of the transmission coils, and the management device instructs each of the transmission coils of the plurality of transmission coils to transmit a detection pulse or ping. In some embodiments, the management device provides (from a power source) a detection pulse current to a first transmission coil proximate to generate a first magnetic field with the first transmission coil.

The detection pulse current applied to the transmission coil does not need to be the full charging current, because the detection pulse needs only to detect the presence of a conductive material proximate the transmission coil but does not need to transmit power to the conductive material. In some embodiments, the detection pulse current applied to the transmission coil (e.g., to generate an analog ping and detect a conductive material proximate the transmission coil) is less than the transmission current used for charging. In some embodiments, the detection pulse current is in a range having an upper value, a lower value, or upper and lower values including any of 50 milliwatts (mW), 100 mW, 200 mW, 300 mW, 400 mW, 500 mW, 600 mW, 700 mW, 700 mW, 700 mW, 1.0 W, 2.0 W, 3.0 W, 5.0 W, 7.5 W, or any values therebetween. In some embodiments, the detection pulse current is greater than 50 mW. In some embodiments, the detection pulse current is less than 7.5 W. In some embodiments, the detection pulse current is between 50 mW and 7.5 W. In some embodiments, the detection pulse current is between 100 mW and 5.0 W. In one example, the detection pulse current is 125 mW.

In some embodiments, the management device alternates between emitting a detection pulse magnetic field from the first transmission coil and emitting a detection pulse magnetic field from the second transmission coil (or other transmission coils in sequence). The duration of each detection pulse is in a range having an upper value, a lower value, or upper and lower values including any of 1 millisecond (1 ms), 5 ms, 10 ms, 15 ms, 20 ms, 25 ms, 50 ms, 100 ms, 250 ms, 1 second, or any value therebetween. In some embodiments, the duration of each detection pulse is greater than 1 ms. In some embodiments, the duration of each detection pulse is less than 1 s. In some embodiments, the duration of each detection pulse is between 1 ms and 1 s. In some embodiments, the duration of each detection pulse is between 5 ms and 250 ms. In some embodiments, the duration of each detection pulse is 10 ms.

The detection pulse and a measured change in the detection pulse current detects the presence of a conductive material in the detection pulse magnetic field. In some embodiments, a subsequent communication (e.g., a digital communication, or series of magnetic field pulses and/or amplitudes) can communicate with a receiver to confirm the conductive material is a receiving coil, and not merely a metallic object, such as a metal desk surface. The subsequent communication can allow data communication with the accessory device through the receiver. For example, a near-field communication “wake up” standard can provide data communication between devices using a magnetic field.

In some embodiments, the method 734 includes determining a proportional alignment value of the receiving coil for at least two of the transmission coils of the plurality of transmission coils at 738. As described herein, in some embodiments, the transmission coil experiences a change in the detection pulse current based on the induction of an induced current in the receiving coil when the receiving coil is present in the charging region. By measuring the change in the detection pulse current, the relative alignment of the receiving coil with the transmission coil producing the detection pulse is measured. A comparison of the relative alignments of the transmission coils proximate the receiving coil allows the management device to determine the proportional alignment value.

As described in relation to FIG. 4-1 through FIG. 5, in some embodiments, the change in the detection pulse current and the associated proportional alignment value is based at least partially on lateral alignment of the receiving coil and the transmission coil. As described in relation to FIG. 6, in some embodiments, the change in the detection pulse current and the associated proportional alignment value is based at least partially on rotational or angular alignment of the receiving coil and the transmission coil.

In some embodiments, the method 734 includes selecting and driving at least one transmission coil of the plurality of transmission coils with a transmission current at 740. In some embodiments, selecting and driving at least one transmission coil includes comparing the proportional alignment value for each transmission coil proximate to the receiving coil. In some embodiments, the proportional alignment value is normalized with the greatest proportional alignment value being normalized to 1.0 and each other proportional alignment value for other transmission coils being scaled proportionately.

In some embodiments, the management device selects the transmission coil with the greatest proportional alignment value. For example, the management device selects the transmission coil with a normalized proportional alignment value of 1.0. In some embodiments, the management device selects any transmission coil with a proportional alignment value greater than 0.0. In some embodiments, the management device selects any transmission coil with a proportional alignment value greater than a threshold value. In some examples, a threshold value of 0.5 causes the management device to select any transmission coil that is at least 50% aligned with the receiving coil (relative to an ideal alignment). In other examples, a threshold value of 0.5 causes the management device to select any transmission coil with a normalized proportional alignment value that is at least half of the greatest proportional alignment value. In some embodiments, the threshold value is no less than 0.1, no less than 0.2, no less than 0.3, no less than 0.4, no less than 0.5, or any value therebetween.

In some embodiments, the management device and/or controller drives a selected coil according to the proportional alignment value(s). For example, the management device and/or controller drives a selected coil based on a transmission current scaled according to the proportional alignment value for the respective transmission coil. In a particular example, a maximum transmission current is 1.0 A, and the proportional alignment value for a first transmission coil is 0.8 and the proportional alignment value for a second transmission coil is 0.2. The management device and/or controller drives the first transmission coil at 0.8 A and drives the second transmission coil at 0.2 A. In another particular example, a maximum transmission current for each transmission coil is 1.0 A, and the proportional alignment value for a first transmission coil is 0.8 and the proportional alignment value for a second transmission coil is 0.2. The management device and/or controller drives the first transmission coil at 1.0 A and drives the second transmission coil at 0.25 A. In at least one example, the first transmission coil has a proportional alignment value of 0.5 and the second transmission coil has a proportional alignment value of 0.5, and the management device and/or controller drives the first transmission coil at equal amperage.

The above embodiments drives the transmission coil with a linear scaling of the transmission current relative to the proportional alignment value. In some embodiments, the transmission current is based on a non-linear relationship with the proportional alignment value.

In some embodiments, the method 734 optionally includes grounding at least one unselected transmission coil at 742. As described herein, when the first transmission coil is driven and is generating a changing magnetic field, the first transmission coil induces an induced current in a second transmission coil adjacent to the first transmission coil. Grounding the second transmission coil protects the second transmission coil, the controller of the second transmission coil (such as the second controllers 422-2 described in relation to FIG. 4-1), a management device of the array of coils (such as the management device 428 described in relation to FIG. 4-1 and/or FIG. 4-2), the electrical conduits therebetween, and other electrical components of the charging device from damage.

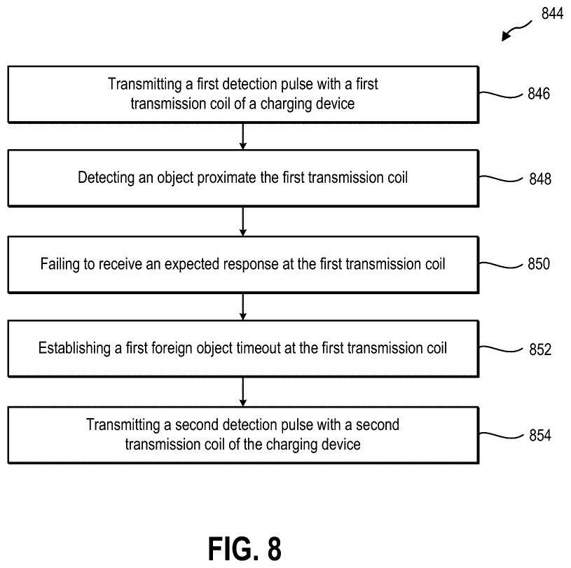

FIG. 8 is a flowchart illustrating an embodiment of a method 844 of providing a foreign object detection (FOD) timeout for one or more transmission coils in a charging device. In some embodiments, the method 844 includes transmitting a first detection pulse with a first transmission coil of a charging device with a plurality of transmission coils at 846 and detecting an object proximate to the first transmission coil with the detection pulse at 848. In some embodiments, transmitting a first detection pulse and detecting an object is performed as described herein.

In some embodiments, the detection pulse is followed by digital pulse communication to attempt to communicate with the receiving coil and/or an electronic device containing the receiving coil. In some embodiments, the management device or controller in communication with the first transmission coil is set to accept an expected response, such as a particular change in the detection pulse current or a response pulse transmitted by the receiving coil in response to the detection pulse. In embodiments in which the first transmission coil confirms the presence of the receiving coil, the management device and/or controller instructs the first transmission coil to begin generating a changing magnetic field with a transmission current.

In some embodiments, the method 844 includes failing to receive an expected response at the first transmission coil at 850. In some embodiments, failing to receive an expected response at the first transmission coil includes receiving a different response than the expected response. For example, an accessory device incompatible with the charging device is located proximate the charging device. In some embodiments, failing to receive an expected response at the first transmission coil includes not receiving a response to the detection pulse or a digital pulse communication for a predetermined period of time, such as 100 ms, 250 ms, 500 ms, or 1 second. In response to failing to receive an expected response, the method 844 includes establishing a first FOD timeout at the first transmission coil for a first FOD timeout duration, in which the first transmission coil does not generate a magnetic field or otherwise transmit energy at 852. In some embodiments, the management device and/or controller grounds a transmission coil during a FOD timeout.

The method 844, in some embodiments, then includes transmitting a second detection pulse with a second transmission coil of the charging device at 854. In some embodiments, a receiving coil is positioned adjacent to the second transmission coil while a foreign object is positioned adjacent to the first transmission coil. In some embodiments, the method 844 includes detecting a receiving coil proximate to the second transmission coil and driving the second transmission coil according to any of the embodiments described herein. In some embodiments, the method 844 includes failing to receive an expected response to the second detection pulse at the second transmission coil, and the management device and/or controller establishes a second FOD timeout at the second transmission coil for a second FOD timeout duration, in which the second transmission coil does not generate a magnetic field or otherwise transmit energy.

In some embodiments, the first FOD timeout and the second FOD timeout are independent of one another. For example, the first FOD timeout and the second FOD timeout start and end independently of one another. In some embodiments, the first FOD timeout and the second FOD timeout are synchronized such that establishing the second FOD timeout resets the first FOD timeout. In such an embodiment, the first FOD timeout and second FOD timeout end at the same time. In an example, the management device and/or controller establishes a first FOD timeout with a 5-second duration, and 1 second later, the management device and/or controller establishes a second FOD timeout with a 5-second duration. Independent FOD timeouts result in the first FOD timeout ending 1 second before the second FOD timeout. Synchronized FOD timeouts result in the establishment of the second FOD timeout resetting the first FOD timeout duration, and the first FOD timeout and the second FOD timeout both end 5 seconds after establishing the second FOD timeout. In some embodiments, establishing a second FOD timeout during a first FOD timeout triggers a total FOD timeout of the charging device, during which no transmission coils generate a magnetic field.

In at least some embodiments, a charging device, according to the present disclosure, allows the use of multi-coil arrays to efficiently and adaptively create magnetic fields in proximity to detected receiving coils through the selection and driving of the transmission coils based at least partially on a proportional alignment value.

### INDUSTRIAL APPLICABILITY

The present disclosure relates generally to systems and methods for charging an electronic device. More particularly, the present disclosure relates to systems and methods for wireless charging of an electronic device. In some embodiments, a user positions an electronic device on or proximate to a charging device to charge the electronic device. In some embodiments, the charging device is part of a standalone dock that supports the charging device and is connected to a power source. In some embodiments, the charging device is part of a host electronic device, such as a laptop computer, tablet computer, desktop computer, hybrid computer, smartphone or other mobile computing device, keyboard, monitor, television, refrigerator, or other electronic device including or connected to a power source. In some embodiments, the charging device is powered by a battery of the host electronic device, and the charging device is limited in power output based on the battery of the host electronic device.

In some embodiments, a charging device includes a transmission coil that produces a magnetic field. The magnetic field of the transmission coil can magnetically couple the transmission coil to a receiving coil of another electronic device to induce an electric current in the receiving coil. The induced electric current, in some embodiments, is used to power one or more components of the electronic device. The induced electric current, in some embodiments, is used to charge a battery of the electronic device.

In some embodiments, a charging efficiency of the magnetic charging between the transmission coil and the receiving coil is proportional to the alignment of the magnetic field of the transmission coil and the receiving coil. For example, the charging efficiency is the amperage of the induced current in the receiving coil relative to a transmission current used to drive the transmission coil. As the distance between the transmission coil and the receiving coil increases, the charging efficiency decreases. As the lateral alignment of the transmission coil and the receiving coil decreases, the charging efficiency decreases.

In some embodiments, a charging device includes a plurality of transmission coils. An array of a plurality of transmission coils can allow a user to position an electronic device in a variety of positions on the charging device and still allow the receiving coil to receive magnetic field to induce a current in the receiving coil. In some embodiments, such as a charging device that is powered by a battery, the transmission current is limited, and the charging device drives the transmission coils proximate to the receiving coil. In some embodiments, driving the transmission coils proximate to the receiving coil conserves power. In some embodiments, the charging device selects a plurality of coils and drives the plurality of coils with transmission currents that are proportional to one another based on a determined relative alignment of the receiving coil proximate the plurality of coils. In some embodiments, the charging device grounds one or more unselected coils.

In some embodiments, a host device has an accessory device docked thereto. In some embodiments, the host device is a laptop computer having a first portion and a second portion that are movable relative to one another, and the accessory device is a stylus that pairs with the host device to provide inputs and inking functionality.

In some embodiments, a processor of the host device is located in the second portion and is in data communication with a transmission coil located in the first portion. When the accessory device is positioned in proximity to the transmission coil, a receiving coil receives a transmission energy from the transmission coil, and the accessory device enters a docked mode. In the illustrated embodiment, the bezel of the first portion that contains the transmission coil acts as the charging device for the accessory device. In some embodiments, the charging device includes a retention mechanism, such as a mechanical retention mechanism, a magnetic retention mechanism, or an adhesive retention mechanism, to hold the accessory device in proximity to the charging device. In some embodiments, the charging device is oriented such that gravity holds the accessory device in proximity to the charging device.

In some embodiments, the accessory device has a housing, with the receiver positioned at or near a surface of the housing. The receiving coil is positioned proximate to a transmission coil of the charging device, such that a transmission energy is transmitted to the receiving coil.

In some embodiments, the transmission energy is transmitted through one or more parts of the accessory device and/or charging device en route to the receiving coil. In some embodiments, the housing of the accessory device and/or a cover of the charging device are at least partly transparent to the transmission energy. In the illustrated embodiment with a transmitter that generates a magnetic field, the cover is a non-magnetic material to allow the transmission energy to pass through the cover to the receiving coil.

In some embodiments, the accessory device is a stylus. In some embodiments, the accessory device is a computing mouse. In some embodiments, the accessory device is a keyboard. In some embodiments, the accessory device is a touch-sensitive device. In some embodiments, the accessory device is an audio device, such as a wireless speaker, headphones, earphones, or other audio device capable of generating audio signals to communicate with a user.

In some embodiments, the host device is a computing device, including but not limited to a laptop computer, hybrid computer, foldable computer, tablet computer, smartphone, wearable computing device, or other computing device. In some embodiments, the host device includes a charging device that contains a transmission coil. The transmission coil produces a magnetic field in an outward direction from the charging device. When a transmission current is applied to the transmission coil in the charging device, the transmission coil generates a magnetic field that extends beyond an outer surface of the charging device.

A receiving coil positioned within the magnetic field proximate the dock experiences the magnetic field. A varying magnetic field induces a current in the receiving coil. In some embodiments, the coils are configured to implement a wireless charging protocol.

In some embodiments, the transmission coil transmits energy from the transmission coil to the receiver to wirelessly charge a power supply of the accessory device. In some embodiments, the power supply is a battery. In some embodiments, the power supply is a capacitor. In some embodiments, the power supply is an AC power source. In some embodiments, the charging device modulates the transmission energy from the transmission coil to the receiving coil to communicate data from the charging device and/or host device to the accessory device. In some embodiments, the host device communicates with the charging device.

In some embodiments, the transmission coil is in electrical communication via an electrical conduit (e.g., a wire) with a controller. The controller is configured to drive the transmission coil with a transmission current from a power source. Changes in the transmission current controlled by the controller cause the transmission coil to produce a changing magnetic field.

In some embodiments, a receiving coil is positioned within the magnetic field. The changes in the magnetic field controlled by the controller induce an induced current in the receiving coil. As described herein, the charging efficiency between the transmission current and the induced current is proportional to the distance between the transmission coil and the receiving coil, as well as proportional to the alignment of the transmission coil and the receiving coil. Distance between the transmission coil and the receiving coil is primarily set by the position of the coils in the respective devices. However, alignment becomes increasingly important in a multi-coil array.

In some embodiments, a multi-coil array contains at least a first transmission coil and a second transmission coil. In some embodiments, each of the transmission coils is in electrical communication with a management device. In some embodiments, the management device is a controller, and the management device directs current from a power source to each of the transmission coils in sequence.

In some embodiments, the receiving coil is aligned with a first transmission coil of the plurality of transmission coils and the management device (e.g., controller) drives the first transmission coil with a transmission current from a power source to create a first magnetic field.

In some embodiments, the receiving coil is misaligned with the first transmission coil and is partially aligned with both the first transmission coil and the second transmission coil. In some embodiments, the management device selects one of the first transmission coil and the second transmission coil to drive with the transmission current. In some embodiments, the management device grounds the unselected transmission coil or otherwise disables the unselected transmission coil. In some embodiments, the management device drives both the first transmission coil with a first transmission current and the second transmission coil with a second transmission current. In some embodiments, the output ratio of the first transmission current and the second transmission current is based at least partially on a proportional alignment value representing the relative alignment of the receiving coil with each of the first transmission coil and the second transmission coil.

In some embodiments, the receiving coil is located approximately 50% aligned with the first transmission coil and 50% aligned with the second transmission coil. In such an example, the proportional alignment value for each of the first transmission coil and the second transmission coil is 0.5. In some embodiments, the receiving coil is located approximately 100% aligned with the first transmission coil and 0% aligned with the second transmission coil. The proportional alignment value for the first transmission coil is approximately 1.0 and the second transmission coil is 0.0.

In some embodiments, a charging device includes a visual indicator, such as one or more LEDs, that activates to indicate the alignment of a receiving coil relative to the transmission coils. In some embodiments, the activation of the visual indicator is based at least partially on the proportional alignment values. For example, a proportional alignment value for the first transmission coil of 1.0 illuminates a first visual indicator at full brightness, and a proportional alignment value for the second transmission coil of 0.5 illuminates a second visual indicator at half brightness.

In some embodiments, the array of transmission coils is in communication with the management device. In some embodiments, the management device is in communication with the transmission coils through controllers associated with each of the transmission coils. The management device instructs each of the controllers to drive the transmission coils with a determined transmission current.

In some embodiments, the management device is a dedicated processor or integrated circuit. In some embodiments, the management device is a general-purpose processor. In some embodiments, the management device is a CPU of the charging device. In some embodiments, the management device is a CPU of a host device (such as the host electronic device described herein).

In some embodiments, a charging device drives a first transmission coil and does not drive the second transmission coil. In some embodiments, the charging device drives the first transmission coil and grounds the second transmission coil. When the first transmission coil is driven and is generating a changing magnetic field, the first transmission coil induces an induced current in the second transmission coil. Grounding the second transmission coil protects the second transmission coil, the controller of the second transmission coil, a management device of the array of coils, the electrical conduits therebetween, and other electrical components of the charging device from damage. In some embodiments, a transmission coil arrangement includes the first transmission coil and second transmission coil substantially in-plane with one another. For example, the first transmission coil is positioned in a first plane and the second transmission coil is positioned substantially co-planar with and in the first plane. In some embodiments, the first transmission coil and second transmission coil are positioned in parallel but non-co-planar planes. In some embodiments, the first transmission coil and second transmission coil are positioned in non-parallel planes.

In some embodiments, the transmission coils are positioned and/or shaped to limit the mutual inductance of an induced current in the other transmission coil. In some embodiments, the transmission coils each have an aspect ratio of no less than 5:1 in a longitudinal direction, and the transmission coils are positioned adjacent to one another in the longitudinal direction. For example, an array of two transmission coils each with an aspect ratio of no less than 5:1 in a longitudinal direction and positioned adjacent to one another in the longitudinal direction has an array aspect ratio of no less than 10:1. In some embodiments, arranging the relatively short aspects of the transmission coils proximate one another limits the inductance of an induced current in the second transmission coil by the magnetic field produced by the first transmission coil.

In some embodiments, a charging device has a plurality of transmission coils out-of-plane with one another. The first transmission coil, the second transmission coil, and the third transmission coil are out-of-plane with one another, and each has a flux axis that is non-parallel to one another. The flux axis is the center axis of the magnetic field (such as the magnetic fields described herein) produced by each transmission coil when driven with a transmission current.

In some embodiments, the magnetic fields of the transmission coils define a charging region in which the receiving coil can receive the magnetic flux and an induced current can be induced in the receiving coil. However, just as with a lateral misalignment, a rotational or angular misalignment of the flux axis and the plane of the receiving coil can limit the charging efficiency. In a power-limited environment or in the interest of conserving power, the charging device determines a proportional alignment value for each of the transmission coils and selects one or more transmission coils to drive to most efficiently transfer energy to the receiving coil.

In some embodiments, at least two of the flux axes are parallel to one another. In some embodiments, at least two of the flux axes are non-parallel to one another. In some embodiments, at least two of the transmission coils are co-planar and the flux axes of the at least two transmission coils are parallel.

In some embodiments, the charging device most efficiently transfers energy to the accessory device containing the receiving coil with the first transmission coil because the first flux axis is substantially normal to the plane of the receiving coil. In some embodiments, the proportional alignment value of the first transmission coil is greater than the proportional alignment value of the second transmission coil and third transmission coil, and a management device of the charging device selects the first transmission coil to drive the first transmission coil. In some embodiments, the management device of the charging device grounds at least one of the unselected transmission coils (e.g., the second transmission coil and third transmission coil). In some embodiments, the management device of the charging device grounds all unselected transmission coils of the charging device.

In some embodiments, a method of wirelessly transferring energy to a receiving coil with a plurality of transmission coils includes determining a presence of a receiving coil in a charging region. In some embodiments, a management device of the charging device is in communication with the plurality of the transmission coils, and the management device instructs each of the transmission coils of the plurality of transmission coils to transmit a detection pulse or ping. In some embodiments, the management device provides (from a power source) a detection pulse current to a first transmission coil proximate to generate a first magnetic field with the first transmission coil.

The detection pulse current applied to the transmission coil does not need to be the full charging current, because the detection pulse needs only to detect the presence of a conductive material proximate the transmission coil but does not need to transmit power to the conductive material. In some embodiments, the detection pulse current applied to the transmission coil (e.g., to generate an analog ping and detect a conductive material proximate the transmission coil) is less than the transmission current used for charging. In some embodiments, the detection pulse current is in a range having an upper value, a lower value, or upper and lower values including any of 50 milliwatts (mW), 100 mW, 200 mW, 300 mW, 400 mW, 500 mW, 600 mW, 700 mW, 700 mW, 700 mW, 1.0 W, 2.0 W, 3.0 W, 5.0 W, 7.5 W, or any values therebetween. In some embodiments, the detection pulse current is greater than 50 mW. In some embodiments, the detection pulse current is less than 7.5 W. In some embodiments, the detection pulse current is between 50 mW and 7.5 W. In some embodiments, the detection pulse current is between 100 mW and 5.0 W. In one example, the detection pulse current is 125 mW.

In some embodiments, the management device alternates between emitting a detection pulse magnetic field from the first transmission coil and emitting a detection pulse magnetic field from the second transmission coil (or other transmission coils in sequence). The duration of each detection pulse is in a range having an upper value, a lower value, or upper and lower values including any of 1 millisecond (1 ms), 5 ms, 10 ms, 15 ms, 20 ms, 25 ms, 50 ms, 100 ms, 250 ms, 1 second, or any value therebetween. In some embodiments, the duration of each detection pulse is greater than 1 ms. In some embodiments, the duration of each detection pulse is less than 1 s. In some embodiments, the duration of each detection pulse is between 1 ms and 1 s. In some embodiments, the duration of each detection pulse is between 5 ms and 250 ms. In some embodiments, the duration of each detection pulse is 10 ms.

The detection pulse and a measured change in the detection pulse current detects the presence of a conductive material in the detection pulse magnetic field. In some embodiments, a subsequent communication (e.g., a digital communication, or series of magnetic field pulses and/or amplitudes) can communicate with a receiver to confirm the conductive material is a receiving coil, and not merely a metallic object, such as a metal desk surface. The subsequent communication can allow data communication with the accessory device through the receiver. For example, a near-field communication “wake up” standard can provide data communication between devices using a magnetic field.

In some embodiments, the method includes determining a proportional alignment value of the receiving coil for at least two of the transmission coils of the plurality of transmission coils. As described herein, in some embodiments, the transmission coil experiences a change in the detection pulse current based on the induction of an induced current in the receiving coil when the receiving coil is present in the charging region. By measuring the change in the detection pulse current, the relative alignment of the receiving coil with the transmission coil producing the detection pulse is measured. A comparison of the relative alignments of the transmission coils proximate the receiving coil allows the management device to determine the proportional alignment value.

In some embodiments, the change in the detection pulse current and the associated proportional alignment value is based at least partially on lateral alignment of the receiving coil and the transmission coil. As described herein, in some embodiments, the change in the detection pulse current and the associated proportional alignment value is based at least partially on rotational or angular alignment of the receiving coil and the transmission coil.

In some embodiments, the method includes selecting and driving at least one transmission coil of the plurality of transmission coils with a transmission current. In some embodiments, selecting and driving at least one transmission coil includes comparing the proportional alignment value for each transmission coil proximate to the receiving coil. In some embodiments, the proportional alignment value is normalized with the greatest proportional alignment value being normalized to 1.0 and each other proportional alignment value for other transmission coils being scaled proportionately.

In some embodiments, the management device selects the transmission coil with the greatest proportional alignment value. For example, the management device selects the transmission coil with a normalized proportional alignment value of 1.0. In some embodiments, the management device selects any transmission coil with a proportional alignment value greater than 0.0. In some embodiments, the management device selects any transmission coil with a proportional alignment value greater than a threshold value. In some examples, a threshold value of 0.5 causes the management device to select any transmission coil that is at least 50% aligned with the receiving coil (relative to an ideal alignment). In other examples, a threshold value of 0.5 causes the management device to select any transmission coil with a normalized proportional alignment value that is at least half of the greatest proportional alignment value. In some embodiments, the threshold value is no less than 0.1, no less than 0.2, no less than 0.3, no less than 0.4, no less than 0.5, or any value therebetween.

In some embodiments, the management device and/or controller drives a selected coil according to the proportional alignment value(s). For example, the management device and/or controller drives a selected coil based on a transmission current scaled according to the proportional alignment value for the respective transmission coil. In a particular example, a maximum transmission current is 1.0 A, and the proportional alignment value for a first transmission coil is 0.8 and the proportional alignment value for a second transmission coil is 0.2. The management device and/or controller drives the first transmission coil at 0.8 A and drives the second transmission coil at 0.2 A. In another particular example, a maximum transmission current for each transmission coil is 1.0 A, and the proportional alignment value for a first transmission coil is 0.8 and the proportional alignment value for a second transmission coil is 0.2. The management device and/or controller drives the first transmission coil at 1.0 A and drives the second transmission coil at 0.25 A. In at least one example, the first transmission coil has a proportional alignment value of 0.5 and the second transmission coil has a proportional alignment value of 0.5, and the management device and/or controller drives the first transmission coil at equal amperage.

The above embodiments drives the transmission coil with a linear scaling of the transmission current relative to the proportional alignment value. In some embodiments, the transmission current is based on a non-linear relationship with the proportional alignment value.

In some embodiments, the method optionally includes grounding at least one unselected transmission coil. As described herein, when the first transmission coil is driven and is generating a changing magnetic field, the first transmission coil induces an induced current in a second transmission coil adjacent to the first transmission coil. Grounding the second transmission coil protects the second transmission coil, the controller of the second transmission coil, a management device of the array of coils (such as the management devices described herein), the electrical conduits therebetween, and other electrical components of the charging device from damage.

In some embodiments, a method of providing a foreign object detection (FOD) timeout for one or more transmission coils in a charging device includes transmitting a first detection pulse with a first transmission coil of a charging device with a plurality of transmission coils and detecting an object proximate to the first transmission coil with the detection pulse. In some embodiments, transmitting a first detection pulse and detecting an object is performed as described herein.

In some embodiments, the detection pulse is followed by digital pulse communication to attempt to communicate with the receiving coil and/or an electronic device containing the receiving coil. In some embodiments, the management device or controller in communication with the first transmission coil is set to accept an expected response, such as a particular change in the detection pulse current or a response pulse transmitted by the receiving coil in response to the detection pulse. In embodiments in which the first transmission coil confirms the presence of the receiving coil, the management device and/or controller instructs the first transmission coil to begin generating a changing magnetic field with a transmission current.

In some embodiments, the method includes failing to receive an expected response at the first transmission coil. In some embodiments, failing to receive an expected response at the first transmission coil includes receiving a different response than the expected response. For example, an accessory device incompatible with the charging device is located proximate to the charging device. In some embodiments, failing to receive an expected response at the first transmission coil includes not receiving a response to the detection pulse or a digital pulse communication for a predetermined period of time, such as 100 ms, 250 ms, 500 ms, or 1 second. In response to failing to receive an expected response, the method includes establishing a first FOD timeout at the first transmission coil for a first FOD timeout duration, in which the first transmission coil does not generate a magnetic field or otherwise transmit energy. In some embodiments, the management device and/or controller grounds a transmission coil during a FOD timeout.

The method, in some embodiments, then includes transmitting a second detection pulse with a second transmission coil of the charging device. In some embodiments, a receiving coil is positioned adjacent to the second transmission coil while a foreign object is positioned adjacent to the first transmission coil. In some embodiments, the method includes detecting a receiving coil proximate to the second transmission coil and driving the second transmission coil according to any of the embodiments described herein. In some embodiments, the method includes failing to receive an expected response to the second detection pulse at the second transmission coil, and the management device and/or controller establishes a second FOD timeout at the second transmission coil for a second FOD timeout duration, in which the second transmission coil does not generate a magnetic field or otherwise transmit energy.

In some embodiments, the first FOD timeout and the second FOD timeout are independent of one another. For example, the first FOD timeout and the second FOD timeout start and end independently of one another. In some embodiments, the first FOD timeout and the second FOD timeout are synchronized such that establishing the second FOD timeout resets the first FOD timeout. In such an embodiment, the first FOD timeout and second FOD timeout end at the same time. In an example, the management device and/or controller establishes a first FOD timeout with a 5-second duration, and 1 second later, the management device and/or controller establishes a second FOD timeout with a 5-second duration. Independent FOD timeouts result in the first FOD timeout ending 1 second before the second FOD timeout. Synchronized FOD timeouts result in the establishment of the second FOD timeout resetting the first FOD timeout duration, and the first FOD timeout and the second FOD timeout both end 5 seconds after establishing the second FOD timeout. In some embodiments, establishing a second FOD timeout during a first FOD timeout triggers a total FOD timeout of the charging device, during which no transmission coils generate a magnetic field.

In at least some embodiments, a charging device, according to the present disclosure, allows the use of multi-coil arrays to efficiently and adaptively create magnetic fields in proximity to detected receiving coils through the selection and driving of the transmission coils based at least partially on a proportional alignment value.

The present disclosure relates to systems and methods for charging electronic devices according to at least the examples provided in the clauses below:
Clause 1. A device comprising: a first transmission coil, wherein the first transmission coil generates a first magnetic field toward a charging region; a second transmission coil adjacent to the first transmission coil, wherein the second transmission coil generates a second magnetic field toward the charging region; and a management device in communication with the first transmission coil and the second transmission coil, the management device configured to: determine a presence of a receiving coil proximate to a first transmission coil and a second transmission coil; determine a proportional alignment value of at least the first transmission coil and the second transmission coil with the receiving coil; and select and drive at least one of the first transmission coil and the second transmission coil according to the proportional alignment values.
Clause 2. The device of clause 1, wherein the management device is a central processing unit.
Clause 3. The device of clause 1 or 2, further comprising: a first controller in data communication with the management device and configured to drive the first transmission coil; and a second controller in data communication with the management device and configured to drive the second transmission coil.
Clause 4. The device of any preceding clause, wherein the first transmission coil and the second transmission coil have an aspect ratio no less than 5:1.
Clause 5. The device of any preceding clause, wherein the first transmission coil is in a first plane and the second transmission coil is substantially co-planar with the first plane.
Clause 6. The device of any preceding clause, wherein the first transmission coil has a first flux axis and the second transmission coil has a second flux axis that is parallel to the first flux axis.
Clause 7. The device of any preceding clause, wherein the management device is further configured to drive a selected transmission coil of the first transmission coil and the second transmission coil according to the proportional alignment value and ground an unselected transmission coil.
Clause 8. The device of any preceding clause, further comprising a visual indicator in data communication with the management device and configured to be activated according to the proportional alignment value.
Clause 9. The device of any preceding clause, wherein the first transmission coil and the second transmission coil are part of a transmission coil array with no less than three transmission coils.
Clause 10. A method comprising: determining a presence of a receiving coil proximate to a first transmission coil and a second transmission coil; determining a proportional alignment value of at least the first transmission coil and the second transmission coil with the receiving coil; and selecting and driving at least one of the first transmission coil and the second transmission coil according to the proportional alignment value.
Clause 11. The method of clause 10, wherein driving at least one of the first transmission coil and the second transmission coil includes grounding at least one of the first transmission coil and the second transmission coil.
Clause 12. The method of clause 10, wherein driving at least one of the first transmission coil and the second transmission coil includes driving both of the first transmission coil and the second transmission coil according to the proportional alignment value.
Clause 13. The method of clause 10, wherein driving at least one of the first transmission coil and the second transmission coil according to the proportional alignment value includes driving at least one of the first transmission coil and the second transmission coil in a linear relationship to the proportional alignment value.
Clause 14. The method of clause 10, wherein driving at least one of the first transmission coil and the second transmission coil according to the proportional alignment value includes driving at least one of the first transmission coil and the second transmission coil in a non-linear relationship to the proportional alignment value.
Clause 15. The method of clause 10, wherein driving at least one of the first transmission coil and the second transmission coil according to the proportional alignment value includes grounding at least one of the first transmission coil and the second transmission coil with a proportional alignment value below a threshold value.
Clause 16. A method comprising: transmitting a first detection pulse with a first transmission coil of a charging device; detecting an object proximate the first transmission coil; failing to receive an expected response at the first transmission coil; establishing a first foreign object timeout at the first transmission coil; and transmitting a second presence detection pulse with a second transmission coil of the charging device.
Clause 17. The method of clause 16, further comprising: detecting an object proximate the second transmission coil; failing to receive an expected response at the second transmission coil; and establishing a second foreign object timeout at the second transmission coil.
Clause 18. The method of clause 17, wherein establishing the second foreign object timeout at the second transmission coil includes resetting the first foreign object timeout at the first transmission coil.
Clause 19. The method of clause 17, wherein establishing the second foreign object timeout at the second transmission coil includes establishing a total foreign object timeout for the charging device.
Clause 20. The method of clause 16, further comprising: receiving an expected response at the second transmission coil; and driving the second transmission coil with a transmission current.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about”, “substantially”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A device comprising:
a first transmission coil, wherein the first transmission coil generates a first magnetic field toward a charging region;
a second transmission coil adjacent to the first transmission coil, wherein the second transmission coil generates a second magnetic field toward the charging region; and
a management device in communication with the first transmission coil and the second transmission coil, the management device configured to:
determine a presence of a receiving coil proximate to a first transmission coil and a second transmission coil;
determine a proportional alignment value of at least the first transmission coil and the second transmission coil with the receiving coil; and
select and drive at least one of the first transmission coil and the second transmission coil according to the proportional alignment values.

2. The device of claim 1, wherein the management device is a central processing unit.

3. The device of claim 1, further comprising:
a first controller in data communication with the management device and configured to drive the first transmission coil; and
a second controller in data communication with the management device and configured to drive the second transmission coil.

4. The device of claim 1, wherein the first transmission coil and the second transmission coil have an aspect ratio no less than 5:1.

5. The device of claim 1, wherein the first transmission coil is in a first plane and the second transmission coil is substantially co-planar with the first plane.

6. The device of claim 1, wherein the first transmission coil has a first flux axis and the second transmission coil has a second flux axis that is parallel to the first flux axis.

7. The device of claim 1, wherein the management device is further configured to drive a selected transmission coil of the first transmission coil and the second transmission coil according to the proportional alignment value and ground an unselected transmission coil.

8. The device of claim 1, further comprising a visual indicator in data communication with the management device and configured to be activated according to the proportional alignment value.

9. The device of claim 1, wherein the first transmission coil and the second transmission coil are part of a transmission coil array with no less than three transmission coils.

10. A method comprising:
determining a presence of a receiving coil proximate to a first transmission coil and a second transmission coil;
determining a proportional alignment value of at least the first transmission coil and the second transmission coil with the receiving coil; and
selecting and driving at least one of the first transmission coil and the second transmission coil according to the proportional alignment value.

11. The method of claim 10, wherein driving at least one of the first transmission coil and the second transmission coil includes grounding at least one of the first transmission coil and the second transmission coil.

12. The method of claim 10, wherein driving at least one of the first transmission coil and the second transmission coil includes driving both of the first transmission coil and the second transmission coil according to the proportional alignment value.

13. The method of claim 10, wherein driving at least one of the first transmission coil and the second transmission coil according to the proportional alignment value includes driving at least one of the first transmission coil and the second transmission coil in a linear relationship to the proportional alignment value.

14. The method of claim 10, wherein driving at least one of the first transmission coil and the second transmission coil according to the proportional alignment value includes driving at least one of the first transmission coil and the second transmission coil in a non-linear relationship to the proportional alignment value.

15. The method of claim 10, wherein driving at least one of the first transmission coil and the second transmission coil according to the proportional alignment value includes grounding at least one of the first transmission coil and the second transmission coil with a proportional alignment value below a threshold value.

16. A method comprising:
transmitting a first detection pulse with a first transmission coil of a charging device;
detecting an object proximate the first transmission coil;
failing to receive an expected response at the first transmission coil;
establishing a first foreign object timeout at the first transmission coil; and
transmitting a second presence detection pulse with a second transmission coil of the charging device.

17. The method of claim 16, further comprising:
detecting an object proximate the second transmission coil;
failing to receive an expected response at the second transmission coil; and
establishing a second foreign object timeout at the second transmission coil.

18. The method of claim 17, wherein establishing the second foreign object timeout at the second transmission coil includes resetting the first foreign object timeout at the first transmission coil.

19. The method of claim 17, wherein establishing the second foreign object timeout at the second transmission coil includes establishing a total foreign object timeout for the charging device.

20. The method of claim 16, further comprising:
receiving an expected response at the second transmission coil; and
driving the second transmission coil with a transmission current.
